(19) United States
(12) Patent Application Publication
(10) Pub. No.: US 2026/0196057 A1
(43) Pub. Date: Jul. 9, 2026

(54) PRECEDING VEHICLE RECOGNITION DEVICE

(71) Applicant: SUBARU CORPORATION, Tokyo (JP)

(72) Inventor: Kazuhiko ITO, Tokyo (JP)

(21) Appl. No.: 19/367,198

(22) Filed: Oct. 23, 2025

(30) Foreign Application Priority Data
Nov. 1, 2024 (JP) 2024-192725

(51) Int. Cl. G06V 20/58; B60W 40/04; G06V 20/56

(52) U.S. Cl. CPC G06V 20/58; G06V 20/588; B60W 40/04; B60W 2554/4041; B60W 2554/4044

(57) ABSTRACT

A preceding vehicle recognition device includes a route calculator, a direction-of-advance calculator, a distance-of-lateral-movement estimator, and a slip determiner. The route calculator calculates a predicted route of a vehicle. The direction-of-advance calculator calculates an estimated direction of advance of a preceding vehicle, based on a vehicle-widthwise inclination of the preceding vehicle. The distance-of-lateral-movement estimator calculates, based on the estimated direction of advance, an estimated distance of lateral movement of the preceding vehicle with respect to the predicted route after an elapse of setting time. The slip determiner determines that the preceding vehicle is slipping, when a difference between an actual distance of the lateral movement of the preceding vehicle with respect to the predicted route after the elapse of the setting time and the estimated distance of the lateral movement is larger than a threshold value.

### CROSS-REFERENCE TO RELATED APPLICATIONS

The present application claims priority from Japanese Patent Application No. 2024-192725 filed on Nov. 1, 2024, the entire contents of which are hereby incorporated by reference.

### BACKGROUND

The disclosure relates to a preceding vehicle recognition device configured to recognize behavior of a preceding vehicle.

In vehicles such as automobiles, driver assistance apparatuses have been put into practical use for the purpose of reducing a burden on a driver in making driving operations and attaining enhanced safety. Generally, these kinds of driver assistance apparatuses are configured to make an automatic emergence braking (AEB) control and an automatic emergency steering (AES) control, for collision avoidance with a preceding vehicle or the like.

To accurately realize the collision avoidance with the preceding vehicle by these controls, it is preferable to recognize in advance whether the preceding vehicle is exhibiting abnormal behavior such as a slip. Regarding this, for example, Japanese Unexamined Patent Application Publication (JP-A) No. 2015-69229 discloses a technique including comparing a direction D2 of a vehicle body of a preceding vehicle calculated based on image data regarding a rear end of the preceding vehicle and a direction d2 of the vehicle body of the preceding vehicle estimated from a tangential direction of a track of the preceding vehicle, and determining that the preceding vehicle is having an abnormality such as a slip when an angle between the direction D2 of the vehicle body and the direction d2 of the vehicle body becomes larger than a threshold value.

### SUMMARY

An aspect of the disclosure provides a preceding vehicle recognition device including a route calculator, a direction-of-advance calculator, a distance-of-lateral-movement estimator, and a slip determiner. The route calculator is configured to calculate a predicted route of a vehicle. The direction-of-advance calculator is configured to calculate an estimated direction of advance of a preceding vehicle, based on a vehicle-widthwise inclination of the preceding vehicle. The distance-of-lateral-movement estimator is configured to calculate, based on the estimated direction of advance, an estimated distance of lateral movement of the preceding vehicle with respect to the predicted route after an elapse of setting time. The slip determiner is configured to determine that the preceding vehicle is slipping, when a difference between an actual distance of the lateral movement of the preceding vehicle with respect to the predicted route after the elapse of the setting time and the estimated distance of the lateral movement is larger than a threshold value.

An aspect of the disclosure provides a preceding vehicle recognition device including a processor. The processor is configured to: calculate a predicted route of a vehicle; calculate an estimated direction of advance of a preceding vehicle, based on a vehicle-widthwise inclination of the preceding vehicle; calculate, based on the estimated direction of advance, an estimated distance of lateral movement of the preceding vehicle with respect to the predicted route after an elapse of setting time; and determine that the preceding vehicle is slipping, when a difference between an actual distance of the lateral movement of the preceding vehicle with respect to the predicted route after the elapse of the setting time and the estimated distance of the lateral movement is larger than a threshold value.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic configuration diagram of a driver assistance apparatus.

FIG. 2 is a view illustrating an example of characteristic points located in horizontal symmetry on a back surface of a preceding vehicle.

FIG. 3 is a flowchart of a slip determination routine as to the preceding vehicle.

FIG. 4 is a diagram of relation between a predicted route of a vehicle and the preceding vehicle.

FIG. 5 is a diagram of the relation between the predicted route of the vehicle and the preceding vehicle.

FIG. 6 is a diagram of an estimated distance of lateral movement of the preceding vehicle.

FIG. 7 is a diagram of relation between the estimated distance of the lateral movement and an actual distance of the lateral movement when the preceding vehicle is not in a slipping state.

FIG. 8 is a diagram of the relation between the estimated distance of the lateral movement and the actual distance of the lateral movement when the preceding vehicle is in the slipping state.

FIG. 9 is a diagram of an amount of movement by travel of the vehicle.

FIG. 10 is a diagram illustrating movement of coordinates on an x-y coordinate system in accompaniment with the travel of the vehicle.

### DETAILED DESCRIPTION

For example, when a vehicle and a preceding vehicle are traveling on a curved road and the vehicle is tracking the preceding vehicle with a constant inter-vehicle distance, a lateral position of the preceding vehicle on an image is kept constant. Accordingly, a track of the preceding vehicle obtained from image data is similar to that on straight travel. Meanwhile, when the vehicle and the preceding vehicle are traveling on the curved road, a direction of a vehicle body of the preceding vehicle calculated from the image data is inclined as predetermined with respect to a direction of a vehicle body of the vehicle. In such a case, the technique in JP-A No. 2015-69229 has possibility of erroneous recognition that the preceding vehicle is slipping.

It is desirable to provide a preceding vehicle recognition device that makes it possible to accurately recognize behavior of a preceding vehicle such as a slip.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description.

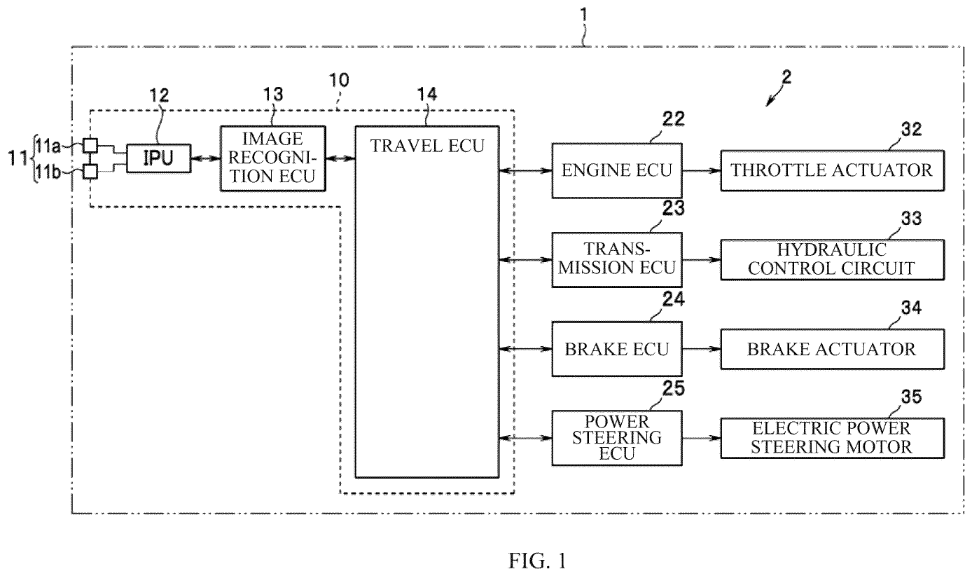

FIG. 1 is a schematic configuration diagram of a driver assistance apparatus for a vehicle.

As illustrated in FIG. 1, a driver assistance apparatus 2 may include a camera unit 10. The camera unit 10 may be fixed to, for example, an upper center of a front portion of a vehicle interior of a vehicle 1.

The camera unit 10 may include a stereo camera 11 as an imaging unit, an image processing unit (IPU) 12, an image recognition unit (image recognition ECU) 13, and a travel control unit (travel ECU) 14.

The stereo camera 11 may include a main camera 11a and a sub-camera 11b. The main camera 11a and the sub-camera 11b may each include an imaging element such as CMOS (Complementary Metal-Oxide Semiconductor). The main camera 11a and the sub-camera 11b may be disposed, for example, at horizontally symmetrical positions with respect to the vehicle-widthwise midpoint of the vehicle. Thus, the main camera 11a and the sub camera 11b may perform stereo-imaging of travel environment frontward of the vehicle from different viewpoints on predetermined imaging cycles synchronized with each other.

The IPU 12 may perform image processing as predetermined, on an image of the travel environment captured by the stereo camera 11. By the image processing, the IPU 12 may detect edges of various targets such as three-dimensional objects that appear on the image or lane lines on a road surface. Moreover, the IPU 12 may obtain distance data from an amount of a positional deviation between of the corresponding edges on the right and left images. Thus, the IPU 12 may generate image data including the distance data regarding each target, i.e., distance image data.

The image recognition ECU 13 may recognize lane lines that define a lane on a road, based on the distance image data received from the IPU 12. For example, the image recognition ECU 13 may obtain curvatures [1/m] of the right and left lane lines that define the lane on the road, and a distance between the right and left lane lines, i.e., a lane width. Moreover, the image recognition ECU 13 may calculate the lane width from a difference between the curvatures of the right and left lane lines. By recognition processing of the lane lines, the image recognition ECU 13 may recognize each lane on the road including a lane on which the vehicle 1 is traveling, i.e., a lane traveled by the vehicle. Furthermore, the image recognition ECU 13 may set, for example, a target route along the right and left lane lines in the middle of the lane traveled by the vehicle.

Moreover, the image recognition ECU 13 may perform predetermined pattern matching or the like on the distance image data. Thus, the image recognition ECU 13 may recognize three-dimensional objects such as guardrails and curbstones extending along the road, and surrounding vehicles traveling on the road.

In the recognition of the three-dimensional objects, the image recognition ECU 13 may recognize, for example, the kinds of the three-dimensional objects, distances to the three-dimensional objects, speeds of the three-dimensional objects, and relative speeds between the three-dimensional objects and the vehicle 1. The image recognition ECU 13 may classify the three-dimensional objects recognized as the surrounding vehicles into, for example: a preceding vehicle 50 traveling on the lane traveled by the vehicle; and a vehicle traveling side-by-side and an oncoming vehicle that are traveling on adjacent lanes. The image recognition ECU 13 may make a slip determination as to whether the preceding vehicle 50 is slipping. The slip determination as to whether the preceding vehicle 50 is slipping is described later.

Various kinds of data thus recognized by the image recognition ECU 13 may be outputted to the travel ECU 14 as travel environment data.

The travel ECU 14 is a control unit configured to make an overall control of the driver assistance apparatus 2.

To the travel ECU 14, various control units may be coupled through an in-vehicle communication line such as a CAN (Controller Area Network). Non-limiting examples of the control units may include an engine control unit (engine ECU) 22, a transmission control unit (transmission ECU) 23, a brake control unit (brake ECU) 24, and a power steering control unit (power steering ECU) 25.

The travel ECU 14 may output various control signals to the engine ECU 22, the transmission ECU 23, the brake ECU 24, and the power steering ECU 25. Thus, the travel ECU 14 may make a driver assistance control. For example, the travel ECU 14 may make an adaptive cruise control (ACC), an active lane keep centering (ALKC) control, and an active lane keep bouncing control, in an appropriate combination. Thus, the travel ECU 14 may allow the vehicle 1 to travel along the target route. The travel ECU 14 may appropriately make a collision avoidance control against an obstacle Ob such as a vehicle that may highly possibly come into contact with the vehicle 1. The collision avoidance control may include, for example, an automatic emergency braking (AEB) control and an automatic emergency steering (AES) control.

The ACC control may be basically made based on the travel environment data inputted from the image recognition ECU 13. The ACC control may be realized by selectively performing a tracking control and a constant-speed travel control.

For example, when the preceding vehicle 50 is registered frontward of the vehicle 1 based on the travel environment data, the travel ECU 14 may make the tracking control. In the tracking control, the travel ECU 14 may set a target inter-vehicle distance based on a vehicle speed of the preceding vehicle 50 and the like. Thus, the travel ECU 14 may make an acceleration/deceleration control to keep the target inter-vehicle distance.

When no preceding vehicles 50 are registered frontward of the vehicle 1, the travel ECU 14 may make the constant-speed travel control. In the constant-speed travel control, the travel ECU 14 may make the acceleration/deceleration control of the vehicle 1 while assuming a setting vehicle speed inputted by a driver who drives the vehicle 1, to be a target vehicle speed. Thus, the travel ECU 14 may maintain a vehicle speed of the vehicle 1 at the setting vehicle speed.

The travel ECU 14 may also make, for example, a feedforward control and a feedback control with respect to steering, based on the data regarding the lane lines, the target route, and the like inputted from the image recognition ECU 13. Thus, the travel ECU 14 may realize the ALKC control and the ALKB control.

The AEB control is a control to avoid, by braking, collision with an obstacle present frontward of the vehicle 1. On the occasion of the AEB control, the travel ECU 14 may extract, as obstacles, a preceding vehicle, a parked vehicle, or the like present in a predetermined region with reference to the target route of the vehicle 1. The travel ECU 14 may calculate predicted collision time TTC with respect to the obstacle. The predicted collision time TTC may be calculated by, for example, dividing a relative distance from the vehicle 1 to the obstacle by a relative speed between the vehicle 1 and the obstacle.

The travel ECU 14 may make a primary brake control when the predicted collision time TTC becomes smaller than a preset first threshold value Tth1. When the primary brake control is started, the travel ECU 14 may allow the vehicle 1 to decelerate, using a preset first target deceleration rate a1. The first target deceleration rate a1 may be, for example, 0.4 G.

The travel ECU 14 may further make a secondary brake control when the predicted collision time TTC becomes smaller than a preset second threshold value Tth2. Note that the second threshold value Tth2 satisfies Tth2<Tth1. When the secondary brake control is started, the travel ECU 14 may allow the vehicle 1 to decelerate, using a preset second target deceleration rate a2until the relative speed to the obstacle becomes “0.” The second target deceleration rate a2 may be, for example, 1 G.

The AES control is a control to avoid, by steering, collision with an obstacle present frontward of the target route of the vehicle 1. For example, when it is determined that the collision with the obstacle is unavoidable by the secondary brake control, the travel ECU 14 may make the AES control in combination with the AEB control.

In one example, the travel ECU 14 may make the AES control when the predicted collision time TTC becomes smaller than a preset third threshold value Tth3. Note that the third threshold value Tth3 satisfies Tth3<Tth2.

On the occasion of the AES control, the travel ECU 14 may set a target lateral position sideward of the obstacle. The travel ECU 14 may also set a new target route to allow the vehicle 1 to reach the target lateral position. For example, the new target route may be set separately for a turning-aside section to allow the vehicle 1 to travel aside from the obstacle, and a turning-back section to return a posture of the vehicle 1 in a direction along the lane traveled by the vehicle. Thus, the travel ECU 14 may make a steering control along the new target route.

To output side of the engine ECU 22, a throttle actuator 32 of an electronic controlled throttle and the like may be coupled. To input side of the engine ECU 22, unillustrated various sensors such as an accelerator sensor may be coupled.

The engine ECU 22 may make a driving control of the throttle actuator 32 and the like, based on the control signals from the travel ECU 14, detection signals from the various sensors, and the like. Thus, the engine ECU 22 may adjust an amount of intake air or the like of an engine to generate a desired engine output. The engine ECU 22 may output signals of, for example, an amount of an accelerator operation detected by the various sensors to the travel ECU 14.

To output side of the transmission ECU 23, a hydraulic control circuit 33 may be coupled. To input side of the transmission ECU 23, unillustrated various sensors such as a shift position sensor may be coupled. The transmission ECU 23 may make a driving control of the hydraulic control circuit 33 and the like, based on an engine torque signal estimated by the engine ECU 22, detection signals from the various sensors, and the like. Thus, the transmission ECU 23 may allow a friction engagement element, a pulley, or the like provided in an automatic transmission to operate, to shift the engine output at a desired shifting ratio. The transmission ECU 23 may output signals of, for example, a shift position detected by the various sensors to the travel ECU 14.

To output side of the brake ECU 24, a brake actuator 34 may be coupled. The brake actuator 34 is configured to adjust brake fluid pressure to be outputted to brake wheel cylinders provided on respective wheels. To input side of the brake ECU 24, unillustrated various sensors may be coupled. Non-limiting examples of the various sensors may include a brake pedal sensor, a yaw rate sensor, a longitudinal acceleration rate sensor, and a vehicle speed sensor.

The brake ECU 24 may make a driving control of the brake actuator 34 and the like, based on the control signals from the travel ECU 14 or detection signals from the various sensors. Thus, the brake ECU 24 may allow each wheel to appropriately generate a braking force to make a compulsive braking control, a yaw rate control, and the like with respect to the vehicle 1. The brake ECU 24 may output signals of, for example, a brake operation state, a yaw rate, a longitudinal acceleration rate, and the vehicle speed detected by the various sensors to the travel ECU 14.

To output side of the power steering ECU 25, an electric power steering motor 35 may be coupled. The electric power steering motor 35 is configured to apply steering torque by a rotational force of a motor to a steering mechanism. To input side of the power steering ECU 25, various sensors may be coupled. Non-limiting examples of the various sensors may include a st eering torque sensor, a steering wheel angle sensor, and a steering angle sensor.

The power steering ECU 25 may make a driving control of the electric power steering motor 35 and the like, based on the control signals from the travel ECU 14 or detection signals from the various sensors. Thus, the power steering ECU 25 may generate the steering torque for the steering mechanism. The power steering ECU 25 may output signals of, for example, the steering torque, a steering wheel angle, and an actual steering angle, i.e., a tire angle σ, detected by the various sensors to the travel ECU 14.

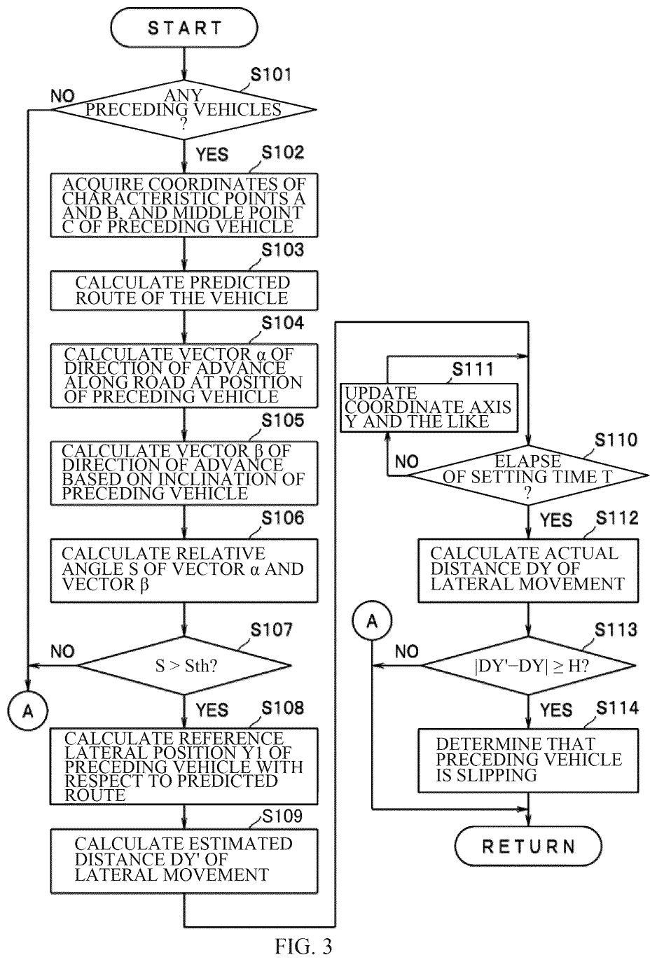

Description is given next of the slip determination as to whether the preceding vehicle 50 is slipping. The slip determination may be made by the image recognition ECU 13. For example, the slip determination may be repeatedly made at every setting time in accordance with a flowchart of a slip determination routine illustrated in FIG. 3. By performing this routine, the image recognition ECU 13 may serve as a “route calculator,” a “direction-of-advance calculator,” a “distance-of-lateral-movement estimator,” and a “slip determiner” in one embodiment of the disclosure.

When the routine starts, in step S101, the image recognition ECU 13 may check presence or absence of any preceding vehicles 50 tracked by the vehicle 1, frontward of the vehicle 1.

In step S101, when it is determined that no preceding vehicles 50 are present (step S101: NO), the image recognition ECU 13 may exit the routine as it is.

In step S101, when it is determined that the preceding vehicle 50 is present (step S101: YES), the image recognition ECU 13 may cause the flow to proceed to step S102.

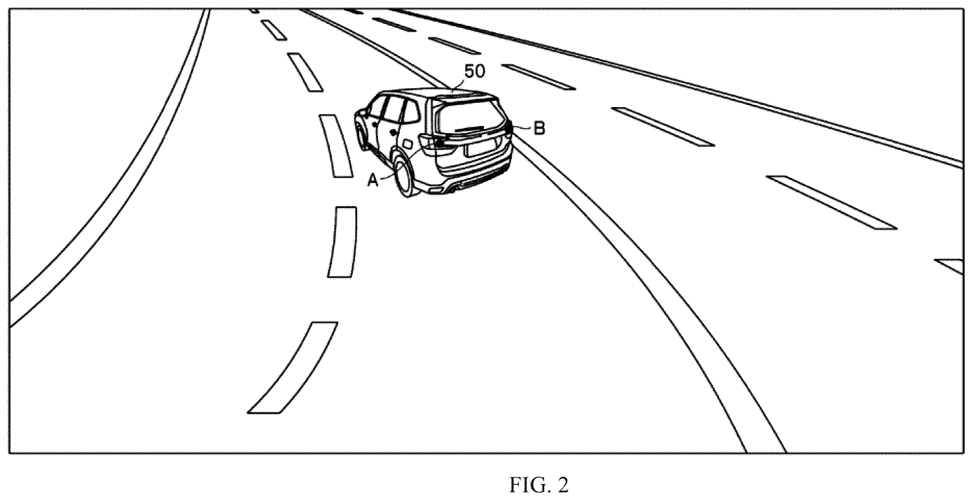

In step S102, the image recognition ECU 13 may extract, for example, a characteristic point A and a characteristic point B in horizontal symmetry on a base end, i.e., a back surface, of the preceding vehicle 50, based on the distance image data. For example, as illustrated in FIG. 2, as the characteristic points A and B, the image recognition ECU 13 may extract, for example, edges of right and left rear combination lamps on the back surface of the preceding vehicle 50.

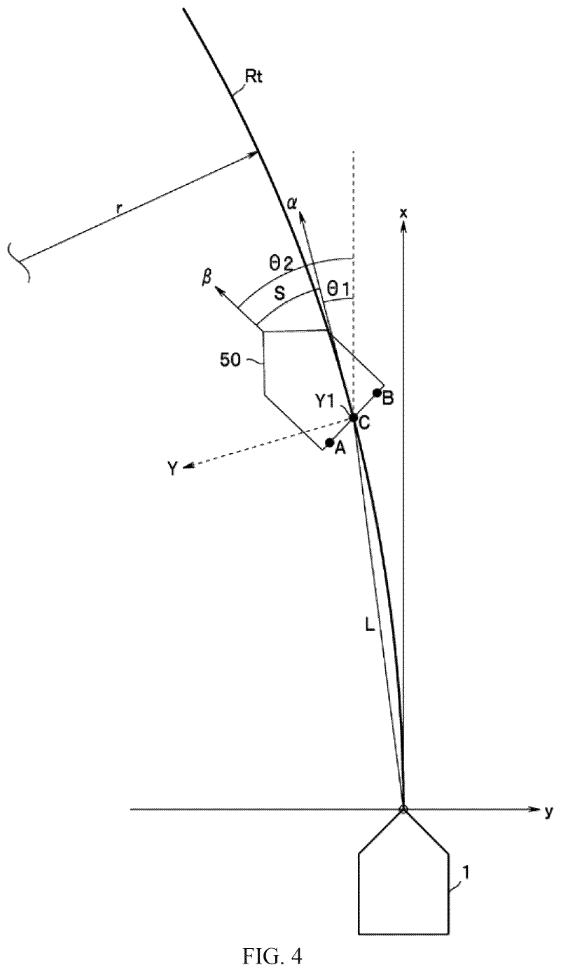

For example, as illustrated in FIG. 4, the image recognition ECU 13 may acquire coordinates of the characteristic points A and B, as coordinates on a bird's-eye-view coordinate system (x-y coordinate system) with the stereo camera 11 of the vehicle 1 as the origin. The image recognition ECU 13 may acquire coordinates of a midpoint between the characteristic point A and the characteristic point B, as coordinates of a middle point C of the preceding vehicle 50.

In step S103, the image recognition ECU 13 may calculate a predicted route Rt of the vehicle 1. Assuming that the vehicle 1 is tracking the preceding vehicle 50, the image recognition ECU 13 is configured to define the predicted route Rt by, for example, a circular arc coupling the vehicle 1 to the middle point C of the preceding vehicle 50 (see FIG. 4).

In this case, for example, the image recognition ECU 13 may calculate a radius r of cornering of the vehicle 1 (radius r of the predicted route Rt) based on the following expression (1).

r=(1+A·V²)/σ (1)

In the expression (1), “V” is the vehicle speed of the preceding vehicle 50. “L” is an inter-vehicle distance (linear distance) from the vehicle 1 to the preceding vehicle 50. “A” is a stability factor of the vehicle 1. “σ” is an actual steering angle (tire angle) of the vehicle 1. As is clear from the expression (1), when the actual steering angle σ of the vehicle 1 is “0,” the radius r of the predicted route Rt becomes “∞,” and the predicted route Rt becomes a straight route.

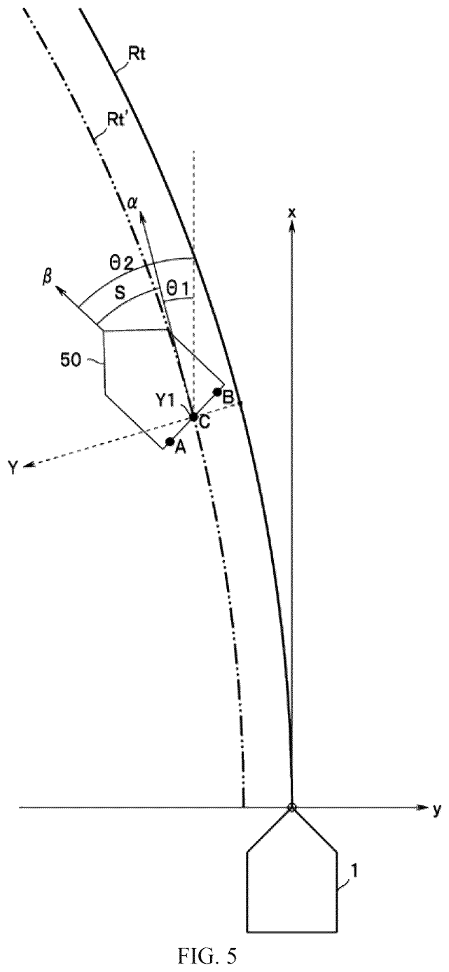

For example, as illustrated in FIG. 5, the image recognition ECU 13 may set a target route along the right and left lane lines, as the predicted route Rt of the vehicle 1.

In step S104, the image recognition ECU 13 may calculate a vector α of a direction of advance of the preceding vehicle 50 along a road at a current position of the preceding vehicle 50. That is, as illustrated in FIG. 4, the image recognition ECU 13 may calculate a vector of a tangential direction of the predicted route Rt at the middle point C of the preceding vehicle 50, as the vector α of the direction of advance of the preceding vehicle 50. The vector α of the direction of advance may be given by, for example, calculating an angle Θ1 of the tangential direction with respect to the direction of advance of the vehicle 1 (x-axis direction) by the following expression (2).

Θ1=sin⁻¹(L/r) (2)

For example, as illustrated in FIG. 5, when the target route is set as the predicted route Rt, there are cases where the middle point C of the preceding vehicle 50 is not present on the predicted route Rt. In such cases, the image recognition ECU 13 may calculate the vector α of the direction of advance of the preceding vehicle 50 using a circular arc Rt′ passing through the middle point C and concentric with the predicted route Rt.

In step S105, the image recognition ECU 13 may calculate a vector β of the direction of advance of the preceding vehicle 50 based on an actual inclination of the preceding vehicle 50. That is, the image recognition ECU 13 may calculate the vector β of the direction of advance of the preceding vehicle 50 in a direction orthogonal to a straight line coupling the characteristic point A to the characteristic point B of the preceding vehicle 50 in the bird's-eye-view coordinate system. It is to be noted that, as illustrated in FIG. 4, an angle Θ2 of the vector β of the direction of advance with respect to the direction of advance of the vehicle 1 (x-axis direction) is uniquely obtained from the characteristic points A and B of the preceding vehicle 50.

In step S106, the image recognition ECU 13 may calculate a relative angle S between the vector α of the direction of advance and the vector β of the direction of advance. That is, the image recognition ECU 13 may calculate the relative angle S using the following expression (3), for example.

S=|Θ2−Θ1| (3)

In step S107, the image recognition ECU 13 may check whether the relative angle S is equal to or larger than a preset threshold value Sth. The threshold value Sth may be set to, for example, a minimum value of an angle of a vehicle body to be assumed by the preceding vehicle 50 with respect to a lane currently traveled, when the preceding vehicle 50 makes a lane change from the lane currently traveled to an adjacent lane, and when the preceding vehicle 50 makes a right turn or a left turn from the lane currently traveled. This threshold value Sth may be set in advance by experimentation, simulations, or the like.

In step S107, when it is determined that the relative angle S is equal to or smaller than the threshold value Sth (step S107: NO), the image recognition ECU 13 may exit the routine as it is.

In step S107, when it is determined that the relative angle S is larger than the threshold value Sth (step S107: YES), the image recognition ECU 13 may cause the flow to proceed to step S108.

In step S108, the image recognition ECU 13 may calculate a reference lateral position Y1 of the preceding vehicle 50 with respect to the predicted route Rt. When calculating the reference lateral position Y1, for example, as illustrated in FIGS. 4 and 5, the image recognition ECU 13 may set a coordinate axis Y passing through the middle point C of the preceding vehicle 50 and having a point at which the coordinate axis Y crosses orthogonal to the predicted route Rt as the origin. The image recognition ECU 13 may calculate the current coordinates of the middle point C on the coordinate axis Y, as the reference lateral position Y1. It is to be noted that, in the example illustrated in FIG. 4, “0” is calculated as the reference lateral position Y1. In the example illustrated in FIG. 5, a value other than “0” is calculated as the reference lateral position Y1.

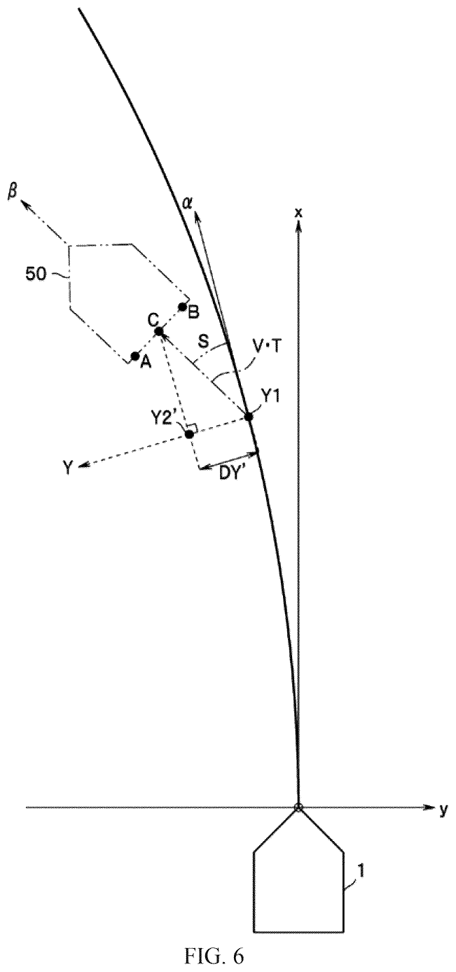

In step S109, the image recognition ECU 13 may calculate an estimated distance DY′ of lateral movement of the preceding vehicle 50 with respect to the predicted route Rt after an elapse of setting time T. As illustrated in FIG. 6, the estimated distance DY′ of the lateral movement may be, for example, a difference (DY′=|Y2′−Y1|) between a coordinate Y2′ (lateral position) of the preceding vehicle 50 on the coordinate axis Y estimated when the preceding vehicle 50 is allowed to travel in a direction of the vector β of the direction of advance at a current vehicle speed V for the setting time T while the preceding vehicle 50 is not slipping, and the reference lateral position Y1. It is possible to calculate the estimated distance DY′ of the lateral movement by, for example, the following expression (4). In one example, the setting time T may be 1 second or less. In another example, the setting time T may be about 0.1 second to 0.2 seconds both inclusive.

DY′=V·T·sin(S) (4)

In step S110, the image recognition ECU 13 may check whether the setting time T has elapsed since the condition S≥Sth is satisfied.

In step S110, when it is determined that the setting time T has not elapsed (step S110: NO), the image recognition ECU 13 may cause the flow to proceed to step S111.

In step S111, the image recognition ECU 13 may update positions of the coordinate axis Y and the like in the x-y coordinate system, e.g., the coordinate axis Y and the points Y1 and Y2′ on the coordinate axis Y, and the like, in accordance with movement of the vehicle 1.

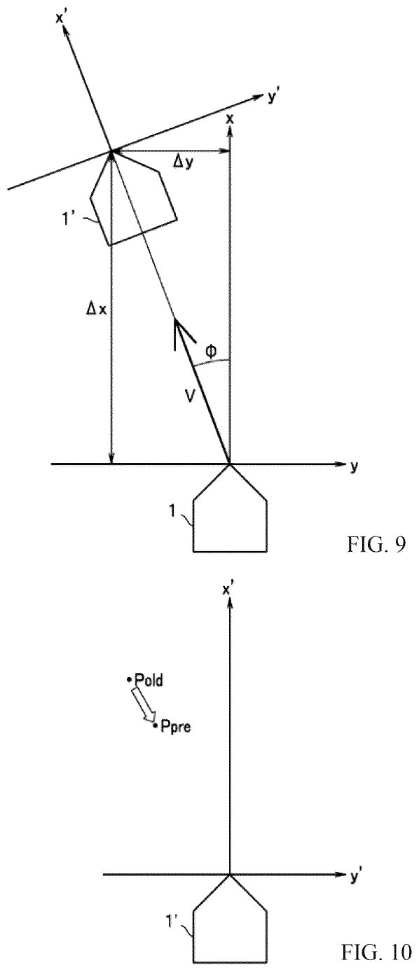

That is, for example, from the relation illustrated in FIG. 9, the image recognition ECU 13 may calculate amounts of movement Δx and Δy of the vehicle 1 at setting time Δt using the following expressions (5) and (6), based on the vehicle speed V of the vehicle 1 and a yaw angle φ obtained from the yaw rate of the vehicle 1. In FIG. 9, the vehicle at the current time, i.e., after the elapse of the setting time Δt, is indicated as the “vehicle 1′,” and the current coordinate system is indicated as an “x′-y′ coordinate system.”

Δy=V·Δt·sinφ (5)

Δx=V·δt·cosφ (6)

Furthermore, as given in the following expressions (7) and (8), coordinates of a point Ppre (xpre, ypre) in the current x′-y′ coordinate system may be calculated by subtracting the amounts of movement Δx and Δy of the vehicle 1 from a point Pold (xold, yold) retroactive by the setting time Δt, and thereafter, performing coordinate transformation to the current x-y coordinate system (see FIG. 10).

ypre=(yold·Δy)·cosφ−(xold·Δx)·sinφ (7)

xpre=(yold·Δy)·sinφ+(xold·Δx)·cosφ (8)

In step S110, when it is determined that the setting time T has elapsed (step S110: YES), the image recognition ECU 13 may cause the flow to proceed to step S112.

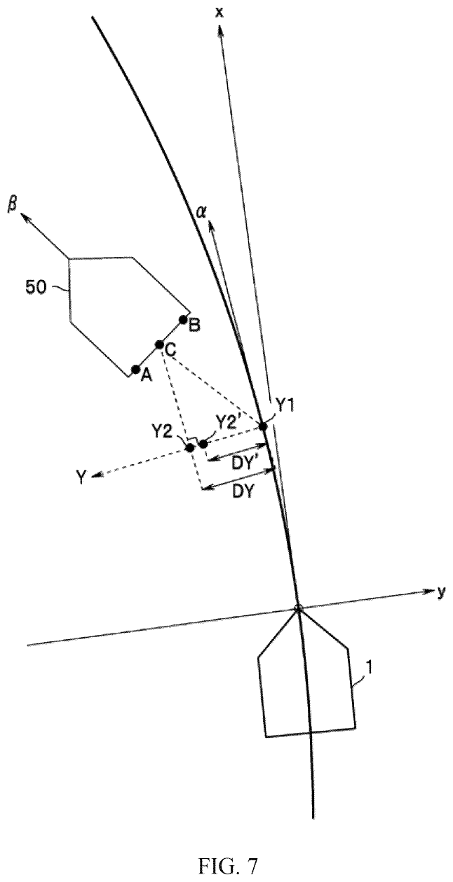

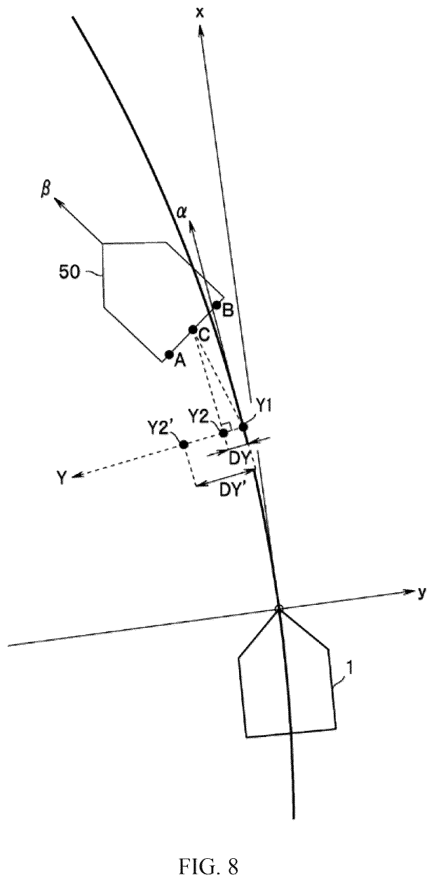

In step S112, the image recognition ECU 13 may calculate an actual distance DY of the lateral movement of the preceding vehicle 50 after the elapse of the setting time T based on the current position of the preceding vehicle 50. That is, for example, as illustrated in FIGS. 7 and 8, the image recognition ECU 13 may calculate a coordinate Y2 of the foot of a vertical line from the middle point C of the preceding vehicle 50 to the coordinate axis Y. Thus, the image recognition ECU 13 may calculate the distance DY of the lateral movement, i.e., a difference (DY=|Y2−Y1|) between the coordinate Y2 (lateral position) of the preceding vehicle 50 on the coordinate axis Y and the reference lateral position Y1.

In step S113, the image recognition ECU 13 may check whether the difference (|DY′−DY|) between the estimated distance DY′ of the lateral movement and the actual distance DY of the lateral movement is equal to or larger than a threshold value H. The threshold value H may be a variable value corresponding to the vehicle speed of the preceding vehicle 50. The threshold value H may be set using a map or the like set in advance. Thus, the image recognition ECU 13 may set the threshold value H that becomes larger as the vehicle speed of the preceding vehicle 50 becomes higher.

In step S113, when it is determined that the difference |DY′−DY| in the distance of the lateral movement is smaller than the threshold value H, the image recognition ECU 13 may exit the routine as it is.

In step S113, when it is determined that the difference |DY′−DY| in the distance of the lateral movement is equal to or larger than the threshold value H, the image recognition ECU 13 may cause the flow to proceed to step S114. That is, when the actual distance DY of the lateral movement is significantly deviated from the estimated distance DY′ of the lateral movement on the assumption that the preceding vehicle 50 is not slipping, the image recognition ECU 13 may cause the flow to proceed to step S114.

When the flow proceeds from step S113 to step S114, the image recognition ECU 13 may determine that the preceding vehicle 50 is slipping, and exit the routine.

Such a recognition result of the preceding vehicle 50 by the image recognition ECU 13 may be outputted to the travel ECU 14. When a determination result that the preceding vehicle 50 is slipping is outputted to the travel ECU 14, the travel ECU 14 may set, for example, the target inter-vehicle distance to the preceding vehicle 50 on tracking travel, to a longer distance than normal. The target inter-vehicle distance on normal travel may be, for example, a target inter-vehicle distance set in accordance with the vehicle speed of the preceding vehicle 50. Alternatively, the travel ECU 14 may set the target vehicle speed on the tracking travel, to a lower speed than normal. The target vehicle speed on the normal travel may be, for example, a target vehicle speed set in accordance with the vehicle speed of the preceding vehicle 50 or a setting vehicle speed. Thus, even when the slipping preceding vehicle 50 suddenly becomes an obstacle to the travel of the vehicle 1, it is possible to realize the AEB control, the AES control, and the like with a sufficient margin.

According to such an embodiment, the image recognition ECU 13 is configured to: calculate the predicted route Rt of the vehicle 1; calculate the vector β of the direction of advance of the preceding vehicle 50 based on the vehicle-widthwise inclination of the preceding vehicle 50; and calculate the estimated distance DY′ of the lateral movement of the preceding vehicle 50 with respect to the predicted route Rt after the elapse of the setting time T, based on the estimated vector β of the direction of advance. The image recognition ECU 13 is configured to determine that the preceding vehicle 50 is slipping, when the difference |DY′−DY| between the actual distance DY of the lateral movement of the preceding vehicle 50 with respect to the predicted route Rt after the elapse of the setting time T and the estimated distance DY′ of the lateral movement is equal to or larger than the threshold value H. Hence, it is possible to accurately recognize the behavior of the preceding vehicle 50 such as a slip.

That is, the image recognition ECU 13 may make the slip determination as to whether the preceding vehicle 50 is slipping, based on the distance of the lateral movement of the preceding vehicle 50 with respect to the predicted route Rt of the vehicle 1. Hence, it is possible to prevent erroneous recognition that the preceding vehicle 50 is slipping, even when the vehicle 1 and the preceding vehicle 50 are traveling on a curved road and an estimated direction of advance of the preceding vehicle 50 is inclined with respect to the direction of advance of the vehicle 1.

The image recognition ECU 13 may calculate the estimated distance DY′ of the lateral movement and make the slip determination based on the estimated distance DY′ of the lateral movement, solely when the angle S between the vector α of the direction of advance of the preceding vehicle 50 along the predicted route Rt and the estimated vector β of the direction of advance of the preceding vehicle 50 is larger than the setting threshold value Sth. Hence, it is possible to suitably reduce a computational load on the image recognition ECU 13.

The image recognition ECU 13 may set the threshold value H with respect to the difference |DY′−DY| in the distance of the lateral movement, to a larger value as the vehicle speed of the preceding vehicle 50, or the vehicle speed of the vehicle 1, becomes higher. Hence, it is possible to set the threshold value H in consideration of the distance to be traveled by the preceding vehicle 50 during the setting time T, leading to enhanced accuracy of the slip determination.

In the forgoing embodiment, some or all of the image recognition ECU 13, the travel ECU 14, the engine ECU 22, the transmission ECU 23, the brake ECU 24, and the power steering ECU 25, and the like may include a processor including hardware. The processor may have a known configuration including, for example, a central processing unit (CPU), a random access memory (RAM), a read only memory (ROM), a non-volatile memory, a non-volatile storage, and the like, and a non-transitory recording medium (non-transitory computer readable medium), and the like, and peripheral devices thereof. The ROM, the non-volatile memory, the non-volatile storage, and the like may hold, in advance, a software program to be executed by the CPU and the like, and fixed data such as a data table. The CPU may read the software program held in the ROM or the like, develop the software program in the RAM, and execute the software program. Moreover, for example, the software program may appropriately refer to various kinds of data and the like. Thus, the CPU, the RAM, the ROM, and the like may serve as each of the components, the constituent units, and the like.

The processor may include a semiconductor chip such as an FPGA (Field Programmable Gate Array). Each of the components, the constituent units, and the like may include an electronic circuit.

The software program may take a form in which a part or all of the software program is held, as a computer program product, in a non-transitory storage medium (non-transitory computer readable medium), e.g., a portable plate medium such as a flexible disk, a CD-ROM, or a DVD-ROM, a card-type memory, a HDD (Hard Disk Drive) device, or an SSD (Solid State Drive) device.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof. The forgoing embodiments include inventions at various stages, and various inventions may be extracted by appropriate combinations of a plurality of disclosed constituent elements.

For example, even if some constituent elements are deleted from the constituent elements described in the forgoing embodiments, a configuration from which the constituent elements are deleted may be extracted as an invention as long as the issues described herein are solved and the effects described herein are produced.

As used herein, the term “collision” may be used interchangeably with the term “contact”.

The image recognition ECU 13, the travel ECU 14, the engine ECU 22, the transmission ECU 23, the brake ECU 24, and the power steering ECU 25 illustrated in FIG. 1 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the image recognition ECU 13, the travel ECU 14, the engine ECU 22, the transmission ECU 23, the brake ECU 24, and the power steering ECU 25. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the image recognition ECU 13, the travel ECU 14, the engine ECU 22, the transmission ECU 23, the brake ECU 24, and the power steering ECU 25 illustrated in FIG. 1.

1. A preceding vehicle recognition device comprising:
a route calculator configured to calculate a predicted route of a vehicle;
a direction-of-advance calculator configured to calculate an estimated direction of advance of a preceding vehicle, based on a vehicle-widthwise inclination of the preceding vehicle;
a distance-of-lateral-movement estimator configured to calculate, based on the estimated direction of advance, an estimated distance of lateral movement of the preceding vehicle with respect to the predicted route after an elapse of setting time; and
a slip determiner configured to determine that the preceding vehicle is slipping, when a difference between an actual distance of the lateral movement of the preceding vehicle with respect to the predicted route after the elapse of the setting time and the estimated distance of the lateral movement is larger than a threshold value.

2. The preceding vehicle recognition device according to claim 1, wherein
the distance-of-lateral-movement estimator is configured to calculate the estimated distance of the lateral movement and the slip determiner is configured to determine whether the preceding vehicle is slippling, when an angle between a direction of advance of the preceding vehicle along the predicted route and the estimated direction of advance is larger than a setting value.

3. The preceding vehicle recognition device according to claim 1, wherein
the slip determiner is configured to set the threshold value to a larger value, as a vehicle speed of the preceding vehicle becomes higher.

4. A preceding vehicle recognition device comprising a processor,
the processor being configured to:
calculate a predicted route of a vehicle;
calculate an estimated direction of advance of a preceding vehicle, based on a vehicle-widthwise inclination of the preceding vehicle;
calculate, based on the estimated direction of advance, an estimated distance of lateral movement of the preceding vehicle with respect to the predicted route after an elapse of setting time; and
determine that the preceding vehicle is slipping, when a difference between an actual distance of the lateral movement of the preceding vehicle with respect to the predicted route after the elapse of the setting time and the estimated distance of the lateral movement is larger than a threshold value.
